(19) United States
(12) Patent Application Publication
(10) Pub. No.: US 2003/0202734 A1
(43) Pub. Date: Oct. 30, 2003

(54) Optical switch

(75) Inventors: Andrew Dames, Cambridge (GB); Victoria Ann Clark, Sunderland (GB)

Correspondence Address: BRUCE E. LILLING, LILLING & LILLING P.C., P.O. BOX 560, GOLDEN BRIDGE, NY, 10526, US

(73) Assignee: Polatis Limited, Cambridge (GB)

(21) Appl. No.: 10/135,250

(22) Filed: Apr. 29, 2002

(51) Int. Cl. G02B 6/35; G02B 6/293; G02B 6/34

(52) U.S. Cl. 385/16; 385/20; 385/37

(57) ABSTRACT

An optical switch comprises an optical input (902) and an optical output (904), the switch further comprising a wavelength selective switch element (912) for directing light of a selected wavelength between the input (902) and the optical output (904), wherein the switch element is tuneable to a plurality of different wavelengths. By having tuneable switch elements, the switch can be made having fewer elements and therefore more compact.

This invention relates to an optical switch. Aspects of the invention described relate to assemblies for directing each radiation of a plurality of wavelengths from a plurality of input guides to a selected one of a plurality of output guides, each wavelength being directed independently.

One of the major aims for an optical switching assembly is to provide rapid switching with low insertion loss (high coupling efficiency and low cross talk) for high port counts, whilst evolving a compact design which can be readily manufactured. A related aim is to increase the switching capacity of an optical fibre switching assembly, without the expense of an increase in physical size.

With the development of DWDM and optical switching has come the need for routing different frequency channels between different fibres. The normal approach is a de-multiplexer/switch plane/multiplexer unit.

International Patent Application No. WO01/07946 describes an optical switching system using electroholographic switches. The apparatus includes a set of wavelength specific filters which act as frequency selective elements which each reflect a particular wavelength of a beam transmitted from an optical input, the particular wavelength being reflected towards an array of electroholographic switches which are set to transmit the wavelength through the switch or reflect the particular wavelength towards one of a plurality of optical outputs.

The electroholographic switches operate at a specific wavelength and may either reflect or transmit the specific wavelength. The apparatus described in Application No. WO01/07946 requires, for each input fibre, M*n electroholographic switches and n frequency selective elements where M is the number of output fibres and n the number of wavelengths in the input beam to be separated. Thus if the apparatus were to be used for an array of m inputs, it would be necessary to have m*M*n electroholographic switches and m*n frequency selective elements, which for a relatively modest number of inputs and outputs can become a prohibitively large number of switches and elements. Aspects of the present invention seek to provide a more compact switching system than that described in WO01/07946.

According to a first aspect of the invention, there is provided an optical switch comprising an optical input and an optical output, the switch further comprising a wavelength selective switch element for directing light of a selected wavelength between the input and an optical output, wherein the switch element is tuneable to a plurality of different wavelengths.

By using a tuneable switch element, the same switch element can be used in the switch to direct different wavelength light at different times. This can allow for the reduction of the number of switching elements required in the switch and thus the size and complexity of the switch assembly can be reduced.

A further aspect of the present invention provides an optical switch including a tuneable wavelength selective switch element.

Preferably the switch comprises a plurality of wavelength selective switch elements.

Preferred embodiments of the invention use an array of switching elements to direct light of different wavelengths and from one or more optical inputs.

Preferably the switch includes a plurality of optical outputs and the switch element is arranged to direct the light between the input and a selected one of the optical outputs.

The term ‘light’ preferably means any form of radiation which can be transmitted using optical guides and switched using an apparatus described herein.

The optical guide can comprise, for example, an optical fibre which conducts laser light, or a waveguide made of silicon or other dielectric material which conducts infrared light. (Reference made herein to optical fibres is by way of example only and can be taken to cover other forms of optical guide.)

Preferably each switch element is tuneable to a Wide range of wavelengths.

Preferably the element is tuneable to any one of the wavelengths of the light to be directed from the optical input to the optical outputs.

In that way, the switch element can be tuned to direct any one of the wavelengths to be directed from the input to an output. In that way greater flexibility in the routing of the light through the switch is obtainable.

Preferably all of the switch elements of the switch are each tuneable to any one of the wavelengths to be directed from the input to the output. Thus still further flexibility in the routing of light through the switch can be obtained.

Preferably the element can be tuned to direct wavelengths from within the fill range of the wavelength of the communication channel; therefore any element can be used to switch any of the wavelengths which might be required to be directed in the switch.

Thus the apparatus can be used for selectively and independently coupling a plurality of wavelengths from each of a plurality of input fibres to each of a plurality of output fibres using frequency selective elements which are each tuneable to any of the communications wavelengths.

For example, under present regulations, the wavelength is preferably tuneable over a range of about 2% centred on a wavelength of 1550 nm. As the range of wavelengths used by devices increases, preferably the elements used for the switches will be ones which are tuneable over all of those possible frequencies. Clearly, if all of the elements are tuneable over the full range of desired frequencies, the flexibility of the switching assembly is increased.

However, it is envisaged that one or more of the elements might be tuneable over less than the full range of wavelengths. For example, one set of elements may be provided which are tuneable over a first range of relatively low wavelengths, one or more further sets being tuneable over further ranges of relatively higher wavelengths.

Preferably the tuneable switch element comprises one or more of a Bragg grating; a fibre Bragg grating; and an etalon.

The tuneable element may be any type of element which may be tuned to separate, for example, transmit or reflect the desired wavelength or range of wavelengths from a beam of more than one wavelength. For example, the tuneable element may comprise a bulk Bragg grating, fibre Bragg grating, an etalon, lithium niobate modulator, electroholographic switch and/or dielectric filter.

Some types of elements such as Bragg gratings transmit most wavelengths and selectively reflect one wavelength only. Other types of elements, for example etalons reflect most wavelengths and selectively transmit one only. This can have an impact on the detail of the switch design and control but either (or both) types of element can be used in an optical switch according to the present invention.

Some elements may transmit or reflect radiation of the particular wavelength, and block other wavelengths.

Where reference is made herein to wavelength, for example the wavelength of a transmitted or reflected light at an element, the reference preferably may also considered to be a reference to the frequency of the light. Also, it will be appreciated that where reference is made to a wavelength or frequency, preferably the reference includes a range or wavelength or frequency. For example, where a switching element is described as reflecting or transmitting a particular wavelength, preferably that refers to a particular desired range of wavelength being reflected or transmitted and/or to a specific wavelength being reflected or transmitted.

Preferably the switch element is electrically tuneable. This has advantages in the control of the element. A further aspect of the invention provides an optical switch including an electrically tuneable element for directing light.

The electroholographic switching elements could be tuned by heating but in some cases this may not be enough. Alternatively, or in addition, the elements could be tuned mechanically by stretching/compressing the element (for example a crystal) using an actuator. If single crystals are used as the elements, they can be controlled singly using separate actuators. If elements are combined, for example by including four elements in a single crystal, the elements might be activated four at a time, but this would be less advantageous as it would lead to less control of the system. Alternatively, a number of gratings can be written to a single multi-wavelength holographic switch, the grating being separated by angle both in writing and in use, the switch being used with an apparatus for changing the angle.

In preferred embodiments of the invention the switch uses an array of widely tuneable frequency selective elements to move the light from transfer paths onto transit paths and then back again onto the transfer paths, the transfer paths passing through the switch, possibly to a beam dump or possibly to an output fibre, the transit paths moving across the fibres. Preferred embodiments of the invention use widely tuneable frequency selective elements to switch individual frequencies between fibres.

The switch is particularly but not exclusively useful in the situation where the channels are sparsely populated and/or in systems in which there are many wavelengths and not all of the wavelengths are to be switched and/or in systems where the wavelengths to be switched varies with time.

Where the optical system is symmetrical, the terms “input” and “output” can be used interchangeably and in a light may be able to be transmitted in either direction.

A broad aspect of the invention provides an optical switch having an optical input and an optical output, and further including a wavelength selective switch element being arranged to direct light from the optical input to the optical output.

The optical input and/or output may comprise an optical guide element, for example an optical fibre, or other element for carrying the light.

Preferably the switch further includes a light transit path for transferring light between an optical input and an optical output, and including a first switch element for directing light from the input onto the light transit path.

Preferably the switch includes a plurality of optical inputs and a plurality of switch elements is arranged to direct light from the plurality of optical inputs onto the light transit path.

Thus the switch can be arranged to “collect” light from more than one input for transferral to one or more of the optical outputs. This can lead to a reduction in size of the switch arrangement as the transit path is used to transfer light from more than one source. In many known switches, a single path is used to transfer light from each input to each output, thus requiring a large number of paths.

Preferably the switch is arranged such that the transit path directs light of a selected wavelength.

Thus a transit path can be used to transfer all of the light of a particular wavelength from all of the inputs of an optical switch, thus potentially greatly reducing the complexity and size of the switch.

Preferably the number of transit paths in a switch is equal to the number of different wavelengths to be switched.

Preferably the switch further includes a second switch element for directing light from the transit path to an optical output.

Thus the transit path can be used to move light of a particular wavelength split from the light at the inputs to one or more desired outputs.

Preferably the switch further includes a light transfer path for transferring light from an optical input to an optical output.

The light transfer path and/or the light transit path may comprise optical guides, for example optical fibres for directing the light, or may be a path in freespace, the light travelling through the ambient medium, for example between the input and switch elements, from one switch element to another and/or from a switch element to an output.

Preferably the transfer path provides a “straight through” path from the input to the output; light of particular wavelength being split off from the transfer path onto a transit path.

Preferably the switch includes a first switching element arranged to direct light of a selected wavelength from a first transfer path to a transit path.

Preferably the switch includes a second switching element arranged to direct light from the transit path onto a second transfer path.

Preferably the second transfer path is a different light transfer path from the one from whence it came. Thus using the light transit paths can shift light from one transfer path to another.

As indicated above, preferably the number of transit paths equals the number of wavelengths to be switched.

Preferably the switch includes a plurality of transit paths and a plurality of switch elements, the number of switch elements being twice the number of transit paths.

Thus each transit path is effectively associated with a switch element to switch light onto the path, and a switch element to switch light off the transit path.

Preferably a transfer path includes a plurality of switching elements for switching a plurality of different wavelengths from the transfer path to the transit paths.

Thus a grid of transit paths and transfer paths built up; at each node is a switch element for switching light between the transit and transfer paths.

Preferably the transfer path includes a break. Preferably the break is downstream of all of the switch elements arranged to transfer light of the desired wavelengths onto the transit paths.

Preferably the transit paths are arranged to return the light to the transfer paths after the break.

The break may literally include a break in the path, which effectively stops light of undesired wavelength passing to the outputs. Alternatively, or in addition, the break may include other elements to remove, manipulate or process the light on the transfer path.

Preferably the switch further includes a mirror element for reflecting light in the switch.

In preferred examples, one or more mirror elements are used to reflect light to direct it between the input and switch elements, between switch elements and between the switch elements and the outputs. Thus the mirror elements can be used to shorten the switch by decreasing path length.

Multiple mirrors can be placed in line to shorten the device. This feature is of particular importance and may be provided independently. A further aspect of the invention provides an optical switch including a plurality of mirror elements for directing light in the switch. For example a set of parallel mirrors can be used so that the light bounces between the mirrors, to shorten the device.

Thus the transfer and/or transit paths can pass between a pair or mirrors or mirror element arrays.

In a preferred example, the transit path is a spiral so that only half of the size of the switch is required compared with a straight path.

Preferably the switch further includes optical input guides and optical output guides.

Preferably the switch includes the same number of inputs as outputs.

Preferably the input guides and output guides are substantially parallel. Thus light passing straight from input to output can pass straight through the switch, which is thought to be better dimensionally. The switch may comprise a parallel DWDM structure. Such a structure can have a diffraction grating. This is particularly important and can be provided separately. The diffraction grating can be used as a switching element and may be tuneable.

Preferably the switch includes a plurality of outputs and separating means for increasing spatial separation of the light beams at the output ports.

The apparatus may include a linear faceted log segment to break up bands to give spatial separation for easy coupling. These features are particularly advantageous and may be provided independently.

Some of the switch channels may be taken to a further assembly which may comprise a further switch, other electrical components, for example to effect frequency shifting, data extraction and/or addition, and/or for connecting to optical components, for example splitters for broadcast.

A further aspect of the invention provides a method of switching light in an optical switch comprising an optical input and a plurality of optical outputs, the switch further comprising a wavelength selective switch element for directing light of a selected wavelength between the input and a selected one of the optical outputs, wherein the method includes the step of tuning the switch element to a selected wavelength.

Preferably the method includes the step of tuning the element to one of the wavelengths of the light to be directed from the optical input to the optical outputs.

Preferably the method includes tuning the element electrically.

A further aspect of the invention provides a method of switching light in an optical switch having an optical input and an optical output, the method including using a wavelength selective switch element to direct light from the optical input to the optical output.

Preferably the method further includes directing light from an input to a light transit path.

Preferably, the method includes directing light from a plurality of inputs to the light transit path.

Preferably the method includes directing light of a selected wavelength onto the transit path.

Preferably the method further includes directing light from the transit path to an optical output.

Preferably the method further includes reflecting light in the switch using a mirror element.

A further aspect of the invention provides a control device for controlling a switch as described herein or for carrying out a method described herein. The invention provides a control device arranged to control the tuning of the switch elements of the switch.

Also provided by the invention is light switched using a switch as described herein or using a method as described herein.

An aspect of the invention provides use of a tuneable wavelength selective switch element in an optical switch.

Also provided by the invention is the use of an electrically tuneable switch element to direct light in an optical switch.

The invention also provides a computer program and a computer program product for carrying out any of the methods described herein and/or for embodying any of the apparatus features described herein, and a computer readable medium having stored thereon a program for carrying out any of the methods described herein and/or for embodying any of the apparatus features described herein.

The invention also provides a signal embodying a computer program for carrying out any of the methods described herein and/or for embodying any of the apparatus features described herein, a method of transmitting such a signal, and a computer product having an operating system which supports a computer program for carrying out any of the methods described herein and/or for embodying any of the apparatus features described herein.

Features implemented in hardware may generally be implemented in software, and vice versa. Any references to software and hardware features herein should be construed accordingly.

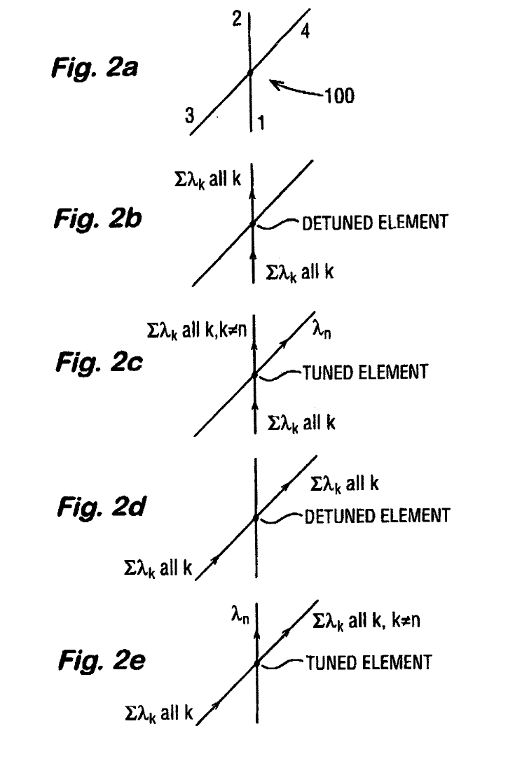

The invention also provides a method being substantially as described herein with reference to any one of FIGS. 2 to 26 of the accompanying drawings, and apparatus substantially as described herein with reference to and as illustrated in the accompanying drawings.

Any feature in one aspect of the invention may be applied to other aspects of the invention, in any appropriate combination.

Preferred features of the present invention will now be described, purely by way of example, with reference to the accompanying drawings, in which:

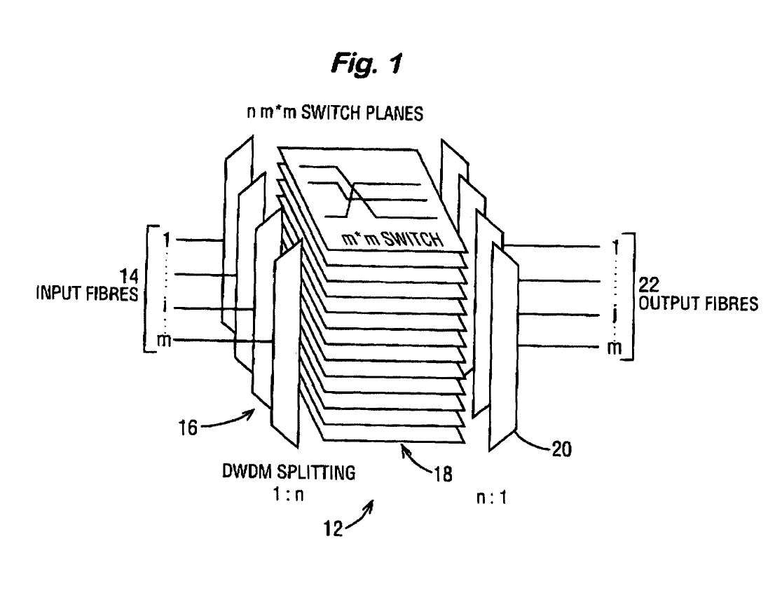

FIG. 1 illustrates a prior art de-multiplexer/switch plane/multiplexer unit;

FIG. 2 illustrates the characteristics of tuneable frequency dependent hybrid elements;

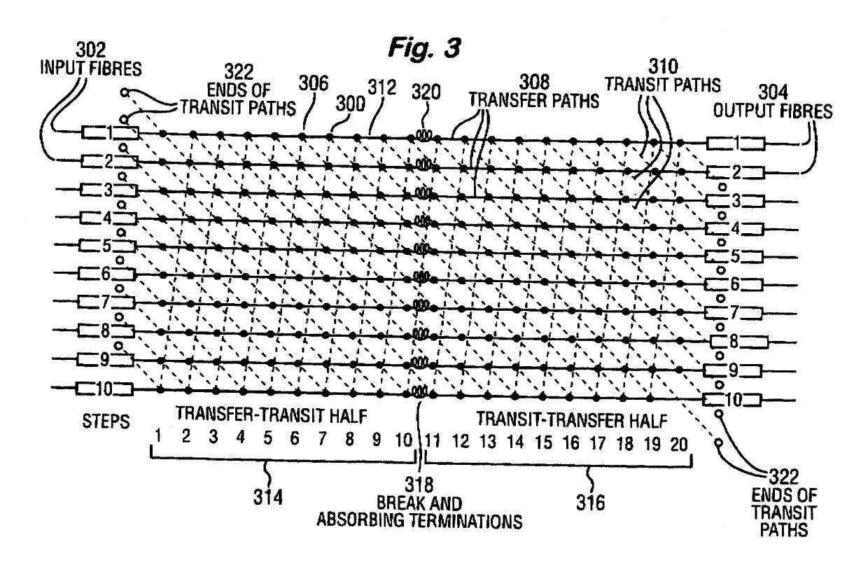

FIG. 3 illustrates the principle of operation of an embodiment of the invention in which the transfer paths are terminated;

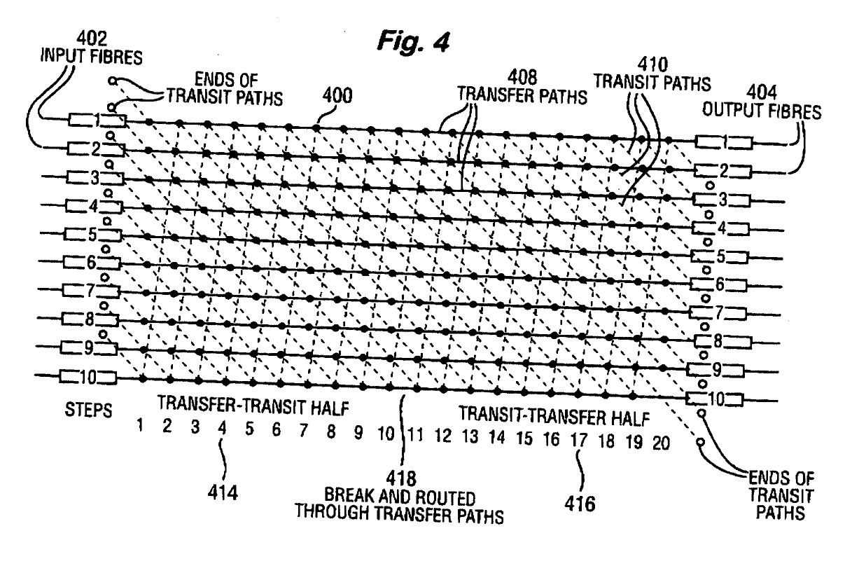

FIG. 4 illustrates the principle of operation of an embodiment of the invention in which the transfer paths pass straight through from the input fibres to the output fibres;

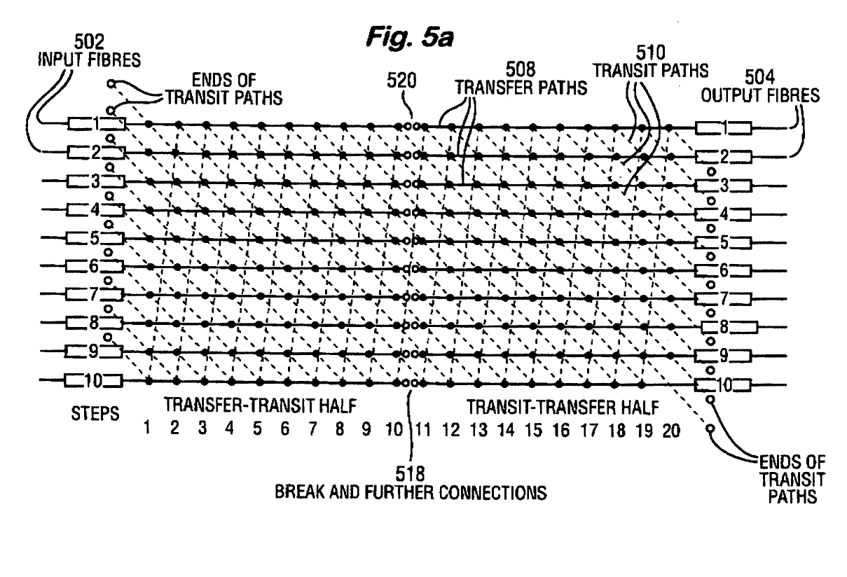

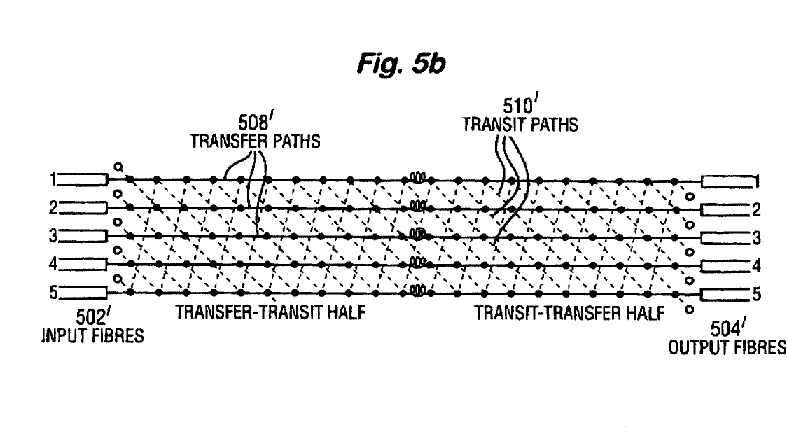

FIG. 5a illustrates the principle of operation of an embodiment of the invention in which there is a break between the input fibres and the output fibres with connections to allow another device to be placed in the middle;

FIG. 5b illustrates the principle of operation for an arrangement having five input and output fibres and ten frequencies to be switched;

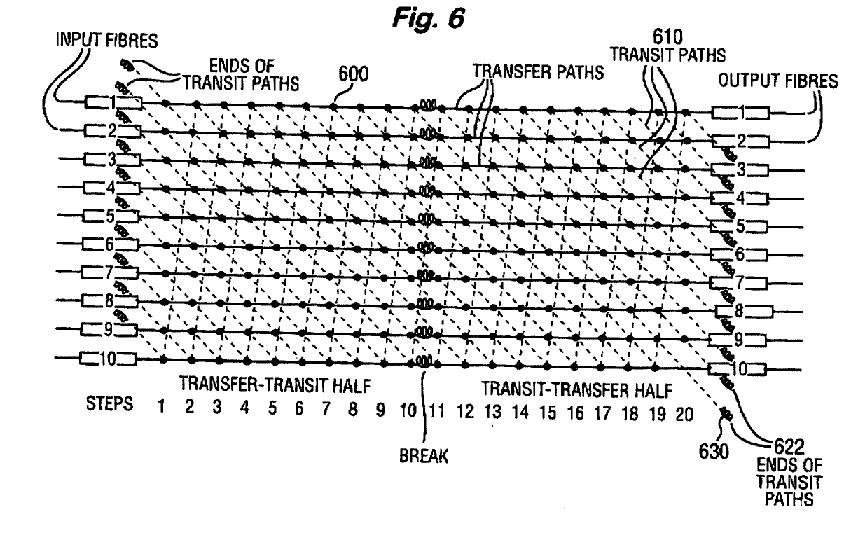

FIG. 6 illustrates the principle of operation of the embodiment of the invention as shown in FIG. 3 incorporating absorbing terminations at the ends of the transfer paths;

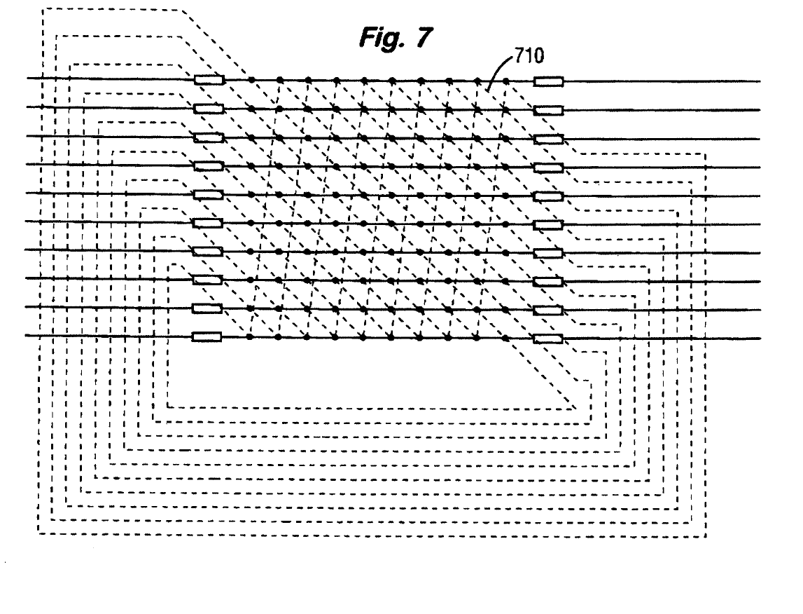

FIG. 7 illustrates the principle of operation of an alternative embodiment of the invention in which the transit paths are connected to form a single continuous spiral;

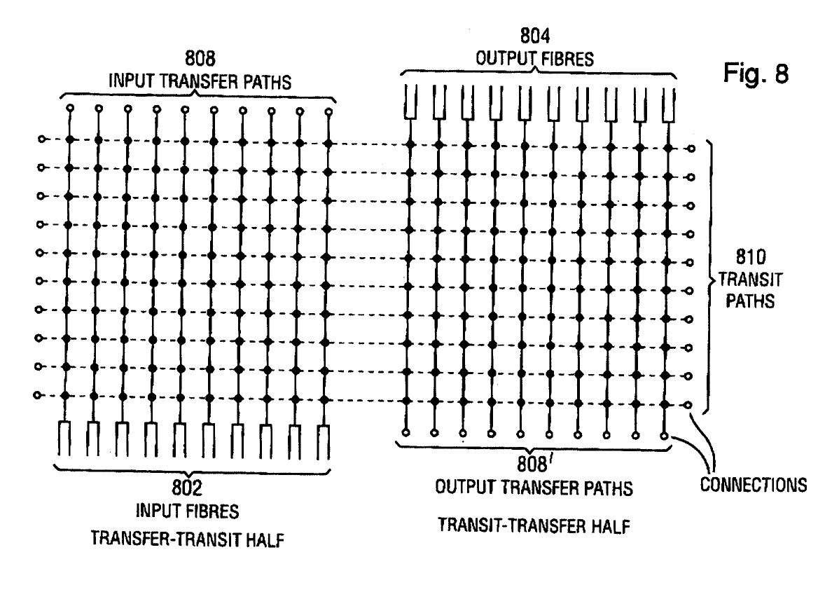

FIG. 8 illustrates a further variant of the geometry shown in FIG. 3;

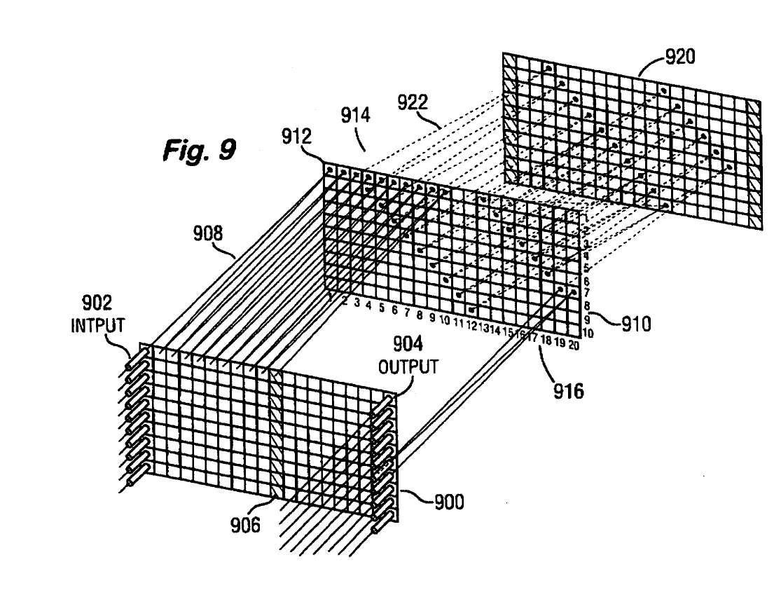

FIG. 9 illustrates an example of the device in FIG. 3;

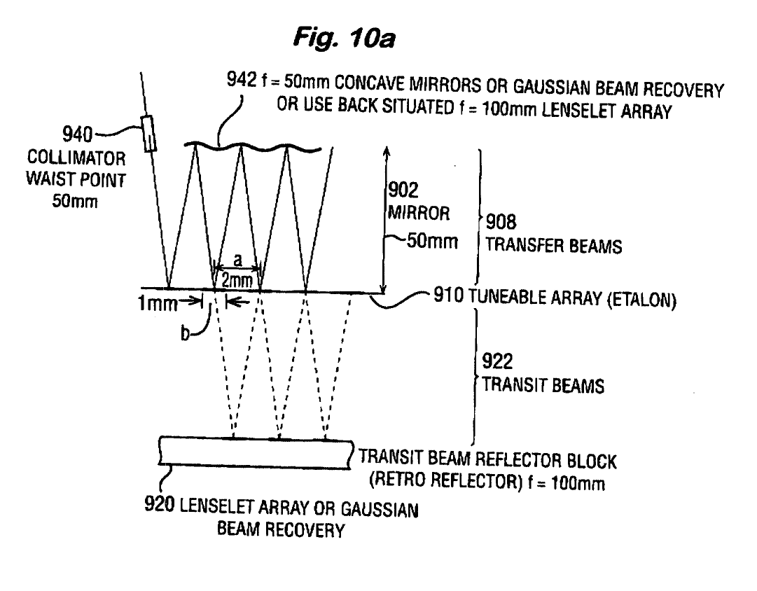

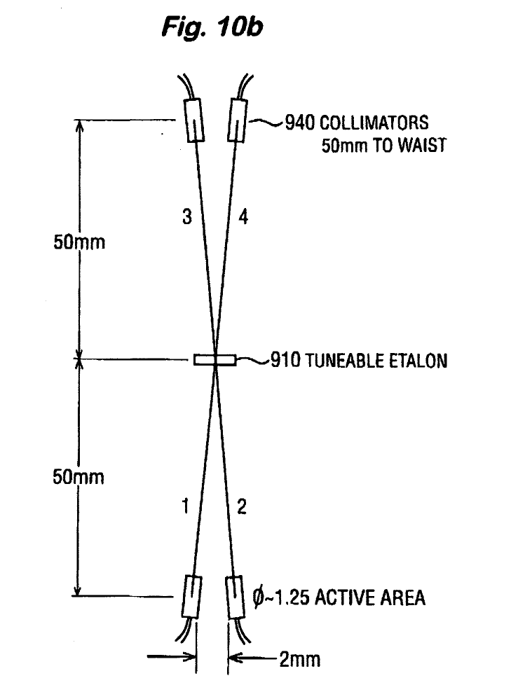

FIG. 10a is a schematic of the light path through part of an apparatus similar to that shown in FIG. 9 but only 3*3 and in plan view;

FIG. 10b illustrates the geometry of the components associated with one element of the free space array;

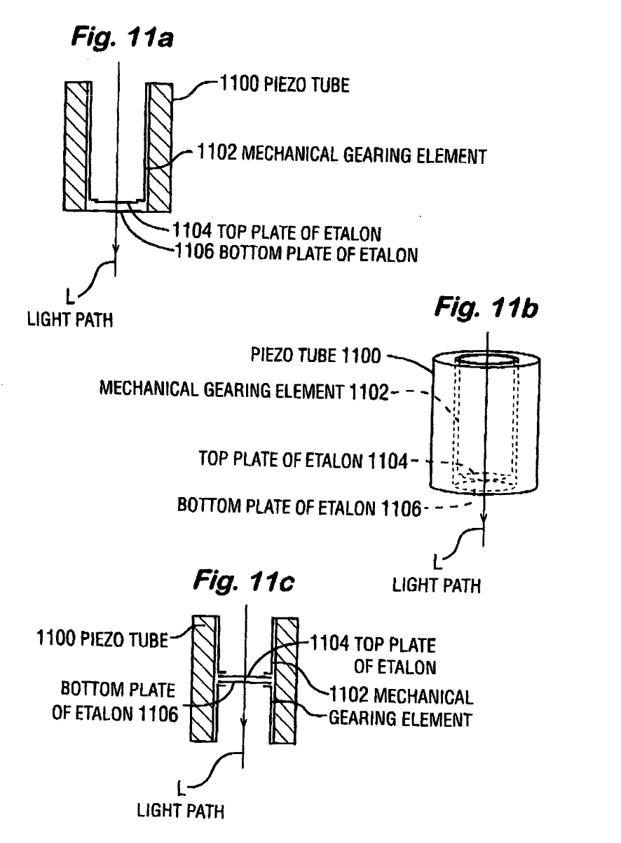

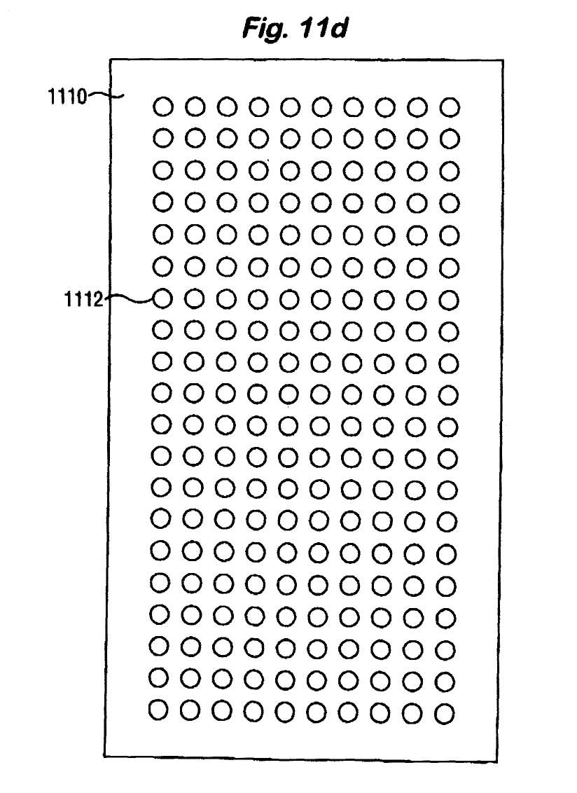

FIGS. 11a, b and c show cross sectional and perspective views of examples of a tuneable element;

FIG. 11d shows a multilayer PCB with an array of holes;

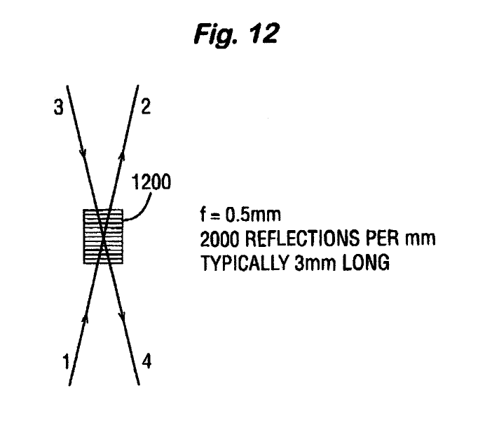

FIG. 12 illustrates the use of Bragg elements in the free space array;

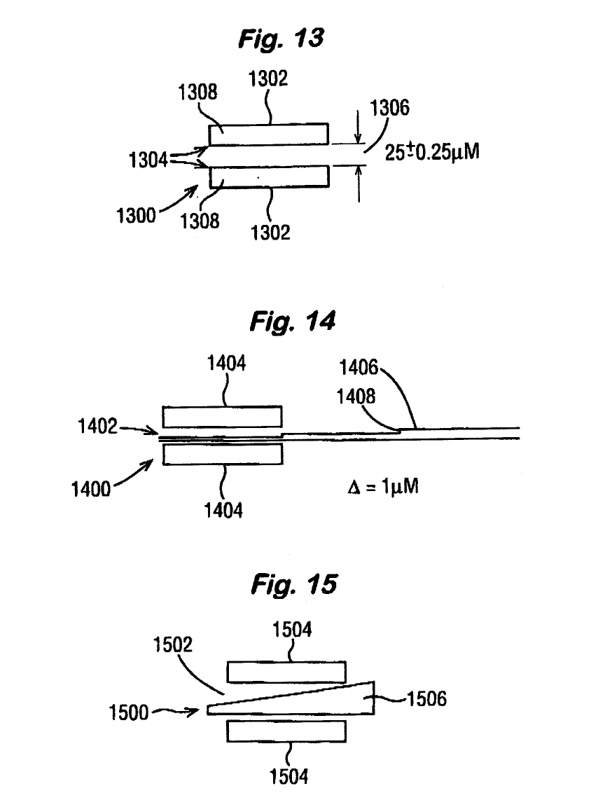

FIG. 13 illustrates a direct etalon;

FIG. 14 illustrates a stepped wedge etalon;

FIG. 15 illustrates a matched taper wedge etalon;

FIG. 16 illustrates an electrically tuned etalon;

FIG. 17 illustrates a mechanically tuned etalon;

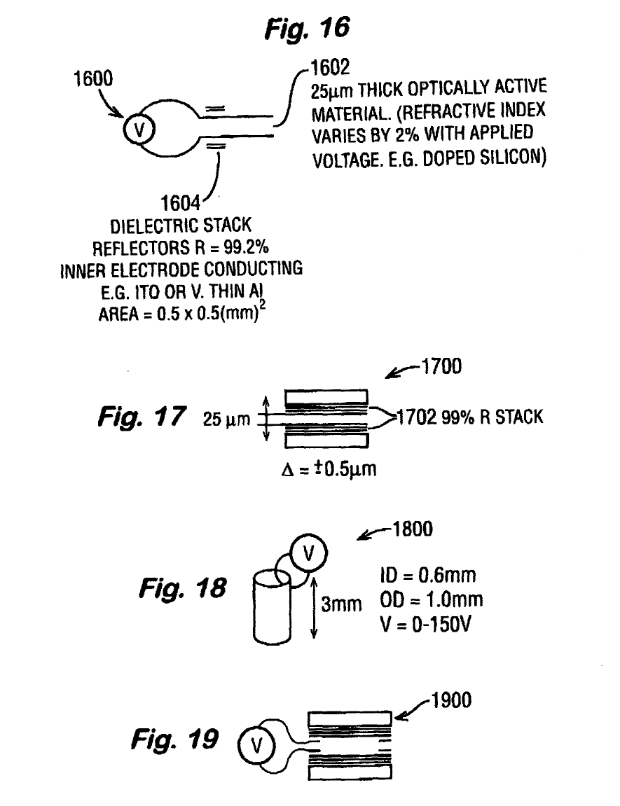

FIG. 18 illustrates a piezoelectric tube etalon;

FIG. 19 illustrates an electrostatic etalon;

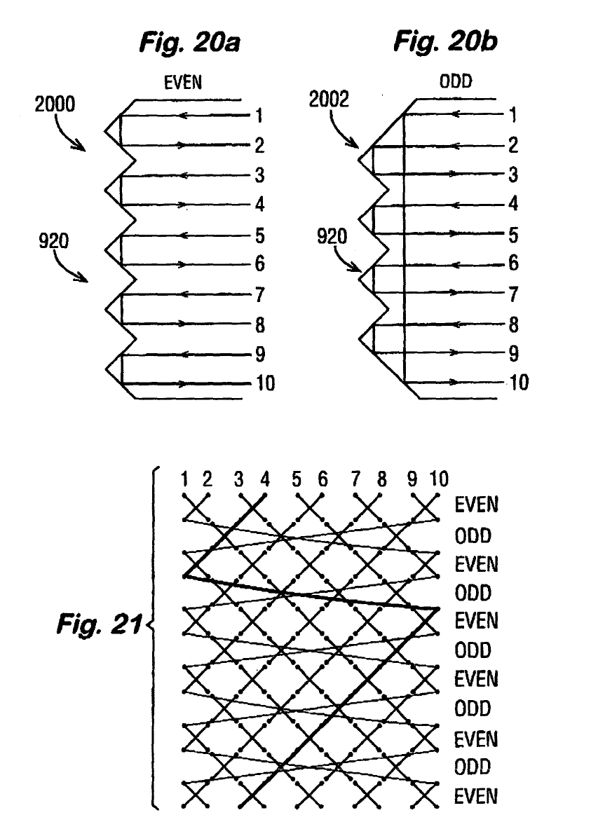

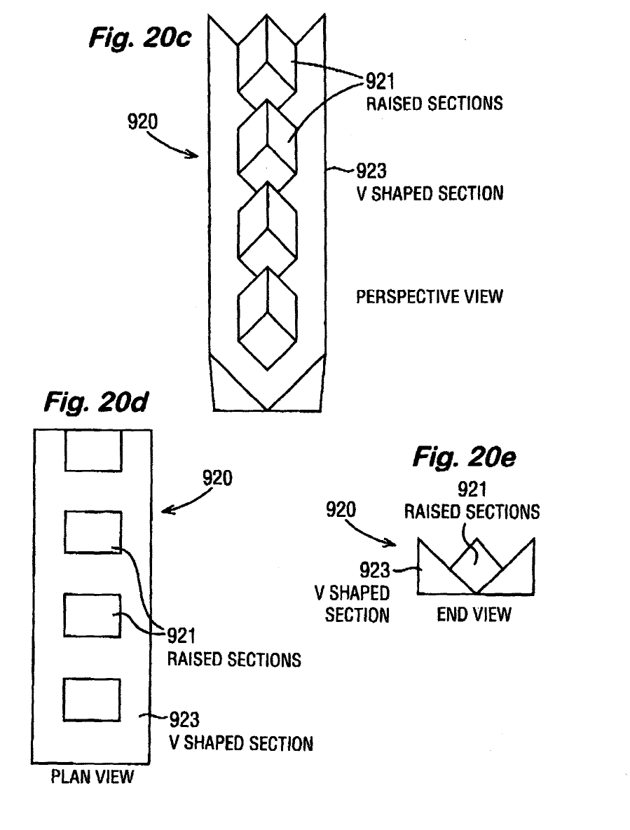

FIGS. 20a and 20b illustrate the reflections that take place on the transit beam reflector block;

FIGS. 20c, d and e show perspective, plan and end views of the beam reflector block;

FIG. 21 illustrates the transit paths resulting from transit beam reflector block as shown in FIGS. 20a and 20b;

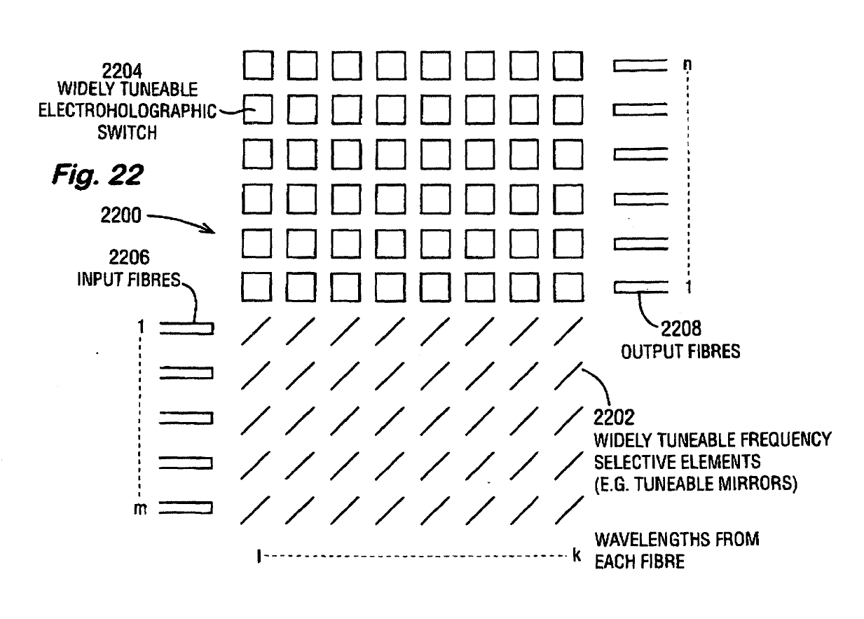

FIG. 22 illustrates the use of electroholographic switches in a free space array;

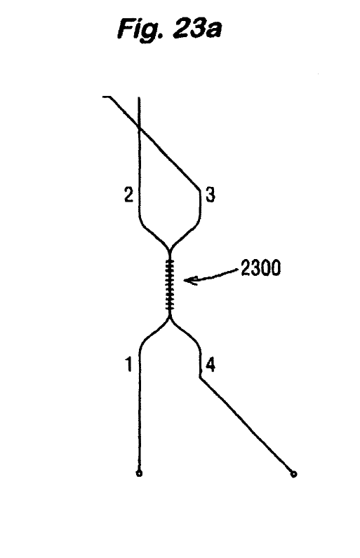

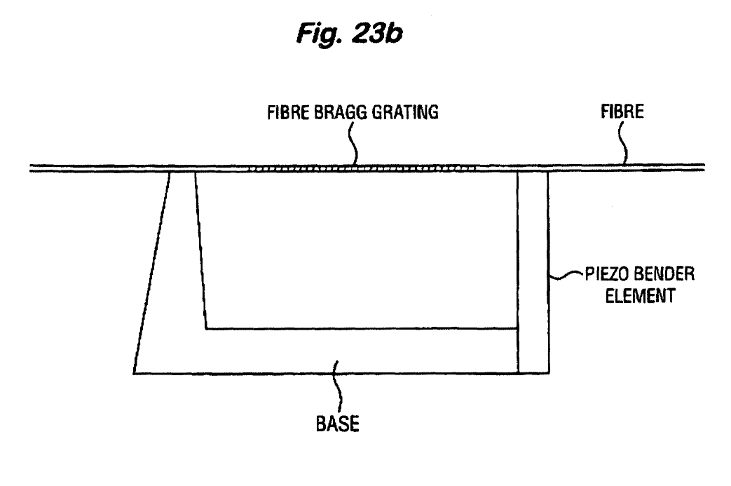

FIG. 23a is a diagram of a fibre Bragg grating element;

FIG. 23b illustrates stretching a fibre Bragg grating can be stretched by, for example, 2%

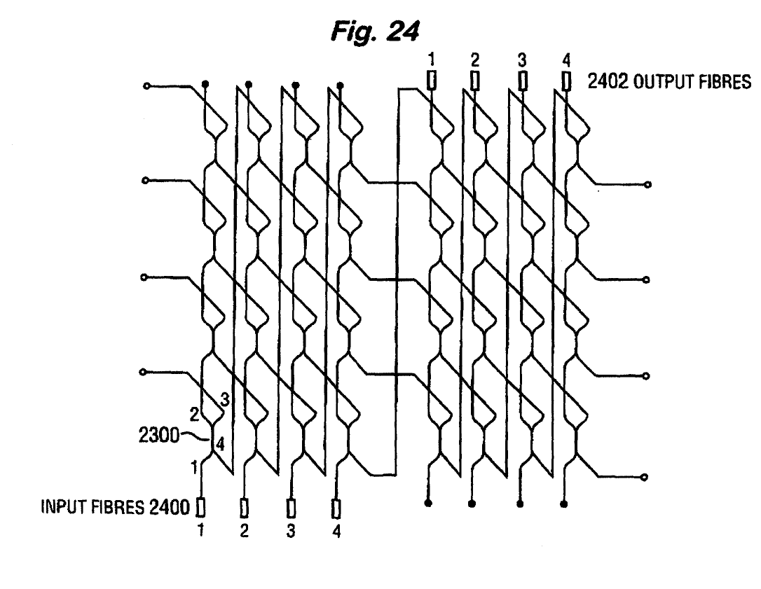

FIG. 24 is a diagram of a 4*4 switch of the type shown in FIG. 3 implemented with fibre Bragg grating elements;

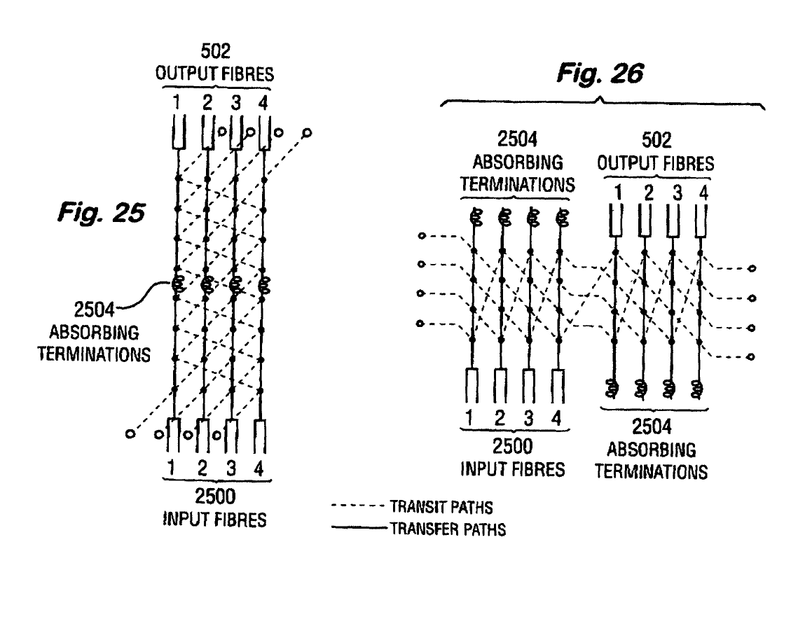

FIG. 25 is a schematic of a device which is the same as the 10*10 switch shown in FIG. 3 but is only 4*4;

FIG. 26 is a schematic of the same switch as shown in FIG. 24 but shown in a different way to better reflect the embodiment diagram in FIG. 22.

A known approach to routing different frequency channels between different fibres is a demultiplexer/switch plane/multiplexer unit 12 as shown in FIG. 1. Here the incoming signal from a given input fibre i (of a total of m fibres 14) is divided into up into its constituent wavelengths 1 . . . k . . . n by the demultiplexer 16 (DWDM splitting 1:n) and each wavelength is directed to a specific switch plane 18 (m*m switch) 1 . . . k . . . n where n is typically 40.

Switch plane k contains the wavelength k from each input fibre 1 . . . i . . . m. There are n (m*m) switch planes. These switch planes swap the wavelengths to the appropriate output fibre. Then the multiplexer unit (n:1) 20 mixes the one signal from each switch plane together to output on output fibre j (of a total of m output fibres 22).

This switch uses:

2m (1:n) frequency splitters/mixers

n (m*m) space switches or 2*m*n steerable elements if 3D switch used (it is believed that one would have n(m*m) space switches in these devices, M(m*m) space switch can be made up of m*m active elements such as beam deflectors in a 2D array or 2m active elements such as beam steerers in a 3D array.)

2*m*n internal fibre interconnects

A failure on any internal port or switch or splitter element will block that channel. The present invention addresses these problems with the de-multiplexer/switch plane/multiplexer unit whilst retaining its functionality and adding flexibility and modularity.

Principles of Operation

FIG. 2 illustrates the characteristics of tuneable frequency dependent hybrid elements. Each element 100 is tuneable across the entire band such that it can be tuned to any of the wavelengths passing into the switch.

As indicated herein, there are various types of tuneable frequency selective elements that could be used, for example a fibre Bragg grating, a bulk Bragg grating, a lithium niobate modulator, an etalon and/or an electroholographic switch, as well as others.

If all wavelengths λₖ pass into the element via channel 1, they should all pass through to channel 2 when the element is not tuned to a wavelength of interest λₖ as shown in FIG. 2b. When the element is tuned to a wavelength λₖ, it passes all wavelengths though to channel 2 except the wavelength λₖ which is passed to channel 4 as shown in FIG. 2c. The element operates reciprocally. If the signal enters into channel 2, it passes through to 1, except the selected wavelength λₖ which is output to channel 3.

If all wavelengths λₖ pass into the switch via channel 3, they should all pass through to channel 4 when the element is not tuned to a wavelength of interest λₖ as shown in FIG. 2d. When the element is tuned to a wavelength λₖ, it passes all wavelengths though to channel 4 except the wavelength λₖ which is passed to channel 2 as shown in FIG. 2e. The element operates reciprocally. If the signal enters into channel 4, it passes through to 3, except the selected wavelength λₖ which is output to channel 1.

According to examples of the present invention, a multiplicity of tuneable frequency dependent hybrid elements are used together to form an all optical space and frequency switch.

FIG. 3 illustrates the principle of operation of an embodiment of the invention. FIG. 3 shows tuneable elements 300, input fibres 302 and output fibres 304.

Each element 300 controls a node point 306 at which there is a possibility of moving between a transfer path 308 and a transit path 310, depending on a state of the element 300. There are 2m*n elements 300 where m is the number of input fibres 302 or the number of output fibres 304, whichever the greater, and n is the number of wavelengths to be switched.

Transfer paths 308 connect, in series, points within the switch which are associated with the same fibre, forming a number of steps 312. The number of steps 312 is equal to or greater than the number of wavelengths to be switched, each on an input transfer-transit half 314 and on an output transit-transfer half 316 giving a total number of steps as twice the number of wavelengths to be switched.

Transit paths move across the fibres either in a grid pattern or in a spiral pattern. In the grid pattern (see below in relation to FIG. 8), the transit paths 810 are perpendicular to the transfer paths 808, the number of transit paths being equal to the number of wavelengths to be switched. In the spiral pattern, the transit paths simultaneously move across the fibres and along the steps, which could be described as geometrically being at an acute angle (say 45 degrees) to the transfer paths, the number of transit paths being equal to the number of input fibres or the number output fibres, whichever the larger. The spiral pattern and grid pattern configurations each lend themselves well to different types of embodiment, for example some of those described herein.

The switch consists of two halves, the transfer-transit half 314 and the transit-transfer half 316. Halfway through the steps there is a break 318 which marks this division in the switch. On the input side of the break the transfer paths refer to the input fibres and wavelengths are selected out from the transfer paths to the transit paths. On the output side of the break the transit paths refer to the output fibres and wavelengths are selected to move from the transit paths back onto the transfer paths.

In the arrangement of FIG. 3, there is a transit path in a spiral pattern and the transfer paths are terminated at the break 318.

There are m input fibres 302 and the same number of output fibres 304 and transfer paths 308. Transfer paths 308 carry the light from one step to the next within the switch directly down the same fibre. The transfer paths 308 travel horizontally across the diagram.

There are the same number of transit paths as there are input fibres (m) or output fibres whichever the greater. Transit paths carry the selected wavelengths across the fibres as they move through the switch. They are the spiralling paths in FIG. 3 that move across the fibres and along the steps. For example, the transit paths move each time both one step forward and one fibre across. In some cases, it is necessary that the transit paths move through the steps and across the fibres rather than purely across the fibres. The number of transit paths is equal to the number of fibres.

There are n wavelengths that require switching. We therefore need twice as many steps as there are wavelengths as we can only move one wavelength from the transfer paths to the transit paths at each step (and they all need to be moved onto transit paths) and there is a requirement to move them back again (from the transit paths to the transfer paths).

If there were more transit paths than there are steps in each half then we would not have the flexibility required to place any wavelength from any input fibre onto any output fibre. Therefore the number of transit paths must be less than or equal to the number of steps in each half, in order to have the flexibility to switch any wavelength from an input fibre to any one of the output fibres. The switch shown in FIG. 3 is a square 10*10 configuration with 10 input (and output) fibres and 10 wavelengths to be switched but a similar switch could have fewer input fibres, and fewer output fibres, and therefore fewer transfer paths and transit paths. FIG. 5b illustrates the principle of operation for an arrangement having five input (and output) fibres and ten wavelengths to be switched. It is possible to have unequal numbers of input and output fibres but the switch would normally be constructed for whichever is the greater, the one with less essentially operating with dummy channels, these dummy channels being terminated with a beam dump for example.

The number of transit paths should be less than or equal to the number of steps in each half in order to be able to have the flexibility to switch any wavelength from any input fibre to any output fibre when the switch is approaching being filly loaded.

The number of frequencies (and hence steps in each half) is greater than or equal to the number of input fibres (and hence, importantly, transit paths).

The switch shown in FIG. 3 is square having ten input fibres and ten wavelengths to be switched. FIG. 5b shows a switch in which there are five input fibres 502′ (output fibres 504′ and transfer paths 508′ and transit paths 510′) and ten frequencies to be switched (and hence ten steps in each half of the switch, there being twenty steps in total).

If the number of input and output fibres is not equal, the switch can be made as if they are the same and equal to whichever is the greater, the empty input or output channels being terminated with a beam dump for example.

The ends of the transit paths are shown 322.

At the break in the transfer paths, different things may be implemented, to provide different functionality.

A suitable absorbing termination 320 could be used at these points as shown in FIG. 3. In this case all wavelengths on the transfer paths 308 (those which have not been moved onto the transit paths) are dumped. This is particularly useful in the case where all wavelengths are switched.

FIG. 4 illustrates the principle of operation of an embodiment of the invention in which the transfer paths 408 pass straight through from the input fibres 402 to the output fibres 404. This would link the residual wavelengths straight through tom the input fibres to the output 10 fibres (after the elements 400 have moved the wavelengths which require switching onto the transit paths 410). Thus the break 418 is routed through the transfer paths 408 from the transfer-transit half 414 to the transit transfer half 416.

FIG. 5a illustrates the principle of operation of an embodiment of the invention in which there is a break 518 between the input fibres 502 and the output fibres 504 with connections 520 to allow another device to be placed in the middle. The device comprises, for example, a switch plane or a tilting mirror arrangement so that the residual wavelengths remaining on the transit paths 510 can be switched between fibres.

There are 2*m*m tuneable elements.

The node points on the schematic map onto the elements of the array in the real device. At each node point there is the possibility of moving in between the transfer paths and the transit paths depending on the state of the element.

Let us assume initially that all wavelengths will be switched. In this case we can switch any wavelength from any fibre onto any other fibre. If there are 10 wavelengths then we have a 10*10 switch with 10 input fibres. This arrangement is illustrated in FIG. 3. There is an absorbing termination between the two halves of the switch.

There are 2*10*10=200 elements.

In another example, there are 20 wavelengths on each fibre. Only 10 need to be switched but the other 10 need to be transferred directly through to the output fibres. This arrangement is illustrated in FIG. 4. The transfer paths are connected directly through. In another example, there are 20 wavelengths on each fibre. Only 10 need to be switched but the other 10 need to be transferred through to the output fibres but may need to be directed to different fibres. The transfer paths are connected through a switch plane or through a tilting mirror arrangement, probably via secondary connections as illustrated in FIG. 5.

FIG. 6 illustrates the principle of operation of the embodiment of the invention as shown in FIG. 3 incorporating absorbing terminations 630 at the ends 622 of the transit paths 610. Alternatively there could be monitoring devices such as diodes or diode—laser pairs at opposite ends, on the ends. Either of these would be appropriate for the system operation described above. Monitoring can allow the frequency response of each tuneable element 600 to be tested, using a low level of laser injection suitably modulated and synchronously detected. This can be done at a low enough energy level to not interfere with the live transmission.

FIG. 7 illustrates the principle of operation of an alternative embodiment of the invention in which the transit paths 710 are connected to form a single continuous spiral. This example is a little different to that which is predominantly described in this disclosure. It allows us to use only half the switch, in other words an array half the size of those described in previous examples, being only m*m, which significantly lowers the number of elements required. However it can be more complicated to control.

FIG. 8 shows a variant on the geometry shown in FIG. 3. In the arrangement shown in FIG. 8, the transfer 808 (input), 808′ (output) and transit paths 810 follow a grid pattern. Here the transit paths are horizontal and pass straight across the diagram and hence across the fibres from input 802 to output 804. There are the same number of transit paths as there are wavelengths to be switched. For a fully non-blocking switch the number of transit paths is equal to the number of wavelengths to be switched and needs to be greater than or equal to the number of input fibres or output fibres, whichever is the greater.

The transfer paths are vertical. The input transfer paths have connectors at the top end as shown in FIG. 8. The output transfer paths have connectors at the bottom end as shown in FIG. 8.

Different things may be implemented at these connectors at the ends of the transfer paths. If the connectors on the input transfer paths are connected to the connectors on the output transfer paths, then any unswitched wavelengths pass straight through the switch. If the connectors on both the input transfer paths and output transfer paths are terminated then any unswitched wavelengths can be dumped, a terminator such as a beam dump or the like being used. Alternatively the connectors can take the remaining wavelengths into a switch plane so that they can be switched in bulk between the fibres.

The connectors at the ends of the transit paths can either be terminated in a beam dump or monitoring may be applied here, one end being detectors and one end a light introducing element at a wavelength which does not interfere with transmission, or both ends being detectors or one end detectors one end beam dump.

This geometry is functionally equivalent to that shown in FIG. 3, but may be implemented using a different technology.

Since all the above examples are 2-stage switches, cross talk performance and loss can be twice as much as that of an individual element. For example if an element has 2 dB loss and 20 dB crosstalk, the overall switch could have 4 dB loss and 40 dB crosstalk.

So far, we have described the switches in the case of a fully non-blocking all wavelength switch. Examples of the present invention are also useful where the data is not to be switched for all wavelengths or where the number of wavelengths present is low i.e. where the fibre is underused. The configuration lends itself well to sparse switches, e.g. where the fibres only have a few of the 40 possible frequencies present but where it is not known in advance which frequencies are present. It is not required that the frequencies are known in advance since any of the elements can be tuned to any of the frequencies.

Let us say that each fibre has about 5 frequencies present to be switched giving five wavelengths to be switched (plus or minus a few) which may be any of a possible 40. From the typical distribution of the frequencies which are used (and thus the likely maximum number of wavelengths to be used), we can calculate the number of steps which are required so that blocking is unlikely to occur. This may be say 10. So in this case we could use a 10*10 switch.

It is in this configuration that we can see serious advantages over the standard multiplexer solution as a much simpler device with much fewer elements is possible. The standard multiplexer cannot utilise the fact that the wavelengths are sparsely populated to use a simpler device. The multiplexer does not have the modularity or flexibility of the present invention.

The switches can be put together in series later when network needs demand: until a fully non-blocking all wavelength switch is reached as and when it is required.

Free Space Example

FIG. 9 illustrates an example corresponding to the device shown in FIG. 3. Referring to FIG. 9, there is a switch including a mirror 900 with the input 902 and output fibres 904 at either side, the mirror 900 having a black absorbing stripe 906 down the middle. This black absorbing stripe 906 acts as an absorbing termination for the transfer paths 908. If the black stripe were simply omitted and the mirror continued then the example would be equivalent to that shown in FIG. 4. If tiltable mirrors were added in place of the black stripe or possibly a switch plane, these being used to steer the remaining wavelengths up or down, then the configuration would be equivalent to that shown in FIG. 5.

There is a freespace array 910 in the middle (centre plane of the switch) which is composed of tuneable elements 912. This is as many elements high as there are input fibres (m) or output fibres (whichever is the greater) and twice as wide (2n) as there are frequencies to be switched. The rows correspond to the input fibres in the left half 914 and the output fibres in the right half 916. The columns correspond to steps, the steps stepping across the array. This array maps onto the nodes on the schematic map shown in FIGS. 3, 4 and 5 and 6.

The tuneable elements 912 may comprise, for example etalons, or other types of tuneable element, for example those described herein.

At the back of the switch there is a transit beam reflector block 920. This is a mirror-like surface which upon reflection moves the incoming beam to a different height vertically whilst allowing the horizontal motion to continue. This could be made of mirrors or prisms for example.

When the beam is on the same side of the array as the fibres, the beam is travelling along the transfer paths shown in FIG. 3. When the beam is on the same side of the array as the transit beam reflector block, the beam is travelling along the transit paths 922. The tuneable frequency dependent hybrid elements are used to switch the beam between these paths and thus allow the beam to be taken from any given fibre and put onto any other fibre.

By way of example a simple operation is described in the system (switch) shown in FIG. 9. This system (switch) consists of 10 fibres with 10 switchable wavelengths. A signal enters the system (switch) through input fibre 1. This (the signal) hits the array at element 1,1 and is reflected since the element is not tuned. This then returns to the mirror and is reflected from there such that when it hits the array again it is at element 1,2. Again this is reflected since the element is not tuned and returns to the mirror. It is once more reflected and hits the array this time at element 1,3. This element is tuned and one wavelength passes through, the remaining wavelengths being reflected.

The remaining (reflected) wavelengths return to the mirror and are reflected to hit the array at element 1,4 where they are reflected and then 1,5 etc to 1,10. After reflection from 1,10, the beam hits the mirror plane and a number of different things may occur depending on the configuration of the switch. The switch shown in FIGS. 3 and 8 is blackened at this point and hence the beam is absorbed. Alternatively there could be a continuation of the plane mirror which is equivalent to the switch shown in FIG. 4. This would result in the continuation of the beam across the array elements 1,11 to 1,20 (where it is always reflected but may have other wavelengths added to it) until it reaches the output fibre 1. Alternatively there is an arrangement that can switch all the remaining data between fibres as shown in FIG. 5. This, for example, consists of secondary output fibres which take the signal through a (m*m) switch plane and then reintroduce it through secondary input fibre or a tiltable mirror arrangement.

The transmitted wavelength passes through to the transit beam reflector block. Here it is reflected such that it returns to the array at 2,4 where it is reflected back to the transit beam reflector block. Here it is reflected such that it returns to the array at 3,5 and then 4,6 5,7 6,8 7,9 8,10 9,11 10,12 1,13 2,14 3,15 4,16 5,17 6,18 at all of which elements it is reflected. Then the beam returns to the array at 7,19. This element is tuned and so it (the radiation of the particular wavelength) is transmitted through. The radiation of that wavelength moves through to the mirror and is reflected such that it returns to the array at 7,20 where it is reflected back to the mirror, where it enters the output fibre.

FIG. 10a is a schematic of the light path through part of a switch similar to that shown in FIG. 9 but only 3*3 (having only three fibres and three wavelengths to switch) and in plan view. FIG. 10a shows only a 3*3 device for clarity and only the first half of the switch. In the top part of the diagram we see the transfer beams bouncing across. In the bottom half the beams also bounce across but also move down one level each time also. This is indicated by different markings for each bounce.

FIG. 10b illustrates how one would set up a tuneable etalon with collimators in free space. Fibres are terminated in collimators 940, for example 1.25 mm diameter collimators from Light Path in Alberquerque (waist point 50 mm). Losses are less than 0.5 dB per collimator pair. There is a gap between the collimators and the etalon of 50 mm which allows for separation of the beams whilst keeping the beams close to perpendicular to avoid walkoff and which is optimised for this collimator pair to give minimum beam width at the array (which is 0.4 mm at that point, 0.6 mm at the collimator). This arrangement benefits from simple manufacture.

With reference to FIG. 10a and b, etalon elements such as those shown in FIG. 10b can be used in the array as shown in FIG. 10a. In the array, most of the elements do not have collimators and fibres at the ports. These are replaced by the plane mirror on one side and the transit beam reflector block on the other side.

The mirror 902 comprise an array of concave mirrors 942 (f=50 mm) or Gaussian beam recovery or a back situated (f═100 mm) lenslet array in order to keep the beam width narrow enough, essentially recovering the same beam shape as is the light were being retransmitted from a collimator at each reflection. The distance between the mirror 902 and the tuneable array 910 is about 50 nm and the arrangement is such that the distance a between the beams at the array 910 is about 2 mm. Each element is about 1 mm in width b.

The transit beam reflector block 920 (retro reflector, f=100 mm) comprises a lenslet array or gaussian beam recovery arrangement in order to keep the beam width narrow enough, essentially recovering the same beam shape as is the light were being re-transmitted from a collimator at each reflection.

The freespace example shown in FIG. 9 (with mirrors and transit beam reflector block) uses an array made of etalons as described below.

Frequency tuneable elements could be etalons such as those made by Queensgate have a piezo actuator in a cylindrical geometry. With reference to FIGS. 1a and b, there is a piezo tube 1100, a mechanical gearing element 1102 which moves the top plate 1104 of the etalon, the bottom plate 1106 of the etalon being fastened directly onto the base of the piezo tube 1100. The light path L is shown. FIG. 11a is a cross-section through the middle, FIG. 11b is a perspective view with some if the internal components indicated although they would not be seen. FIG. 11c illustrates an alternative example of the etalon element in which both the top and bottom plates of the etalon are connected to the piezo tube by mechanical gearing elements, neither being directly attached to the piezo tube, the mechanical gearing elements being the same as one another. This places the etalon in the middle of the tube which allows the optical path to be further from normal to the plates of the etalon, if this is desired.

Capacitive sensing can be applied to this etalon element either using electrodes on the inner surface of the piezo tube (which comprise silver coated electrodes) or ITO (indium tin oxide) electrodes on the surfaces of the etalon. The methods for applying this are well known in the art.

The etalons are glued into a multilayer PCB 1110 with an array of holes 1112 in it (see FIG. 11d) which provides connections to the monitoring and control electronics. The type of piezo tube (for example the material from which it is made) is chosen so that its maximum loaded change in length Δ1 is large enough so that when transferred directly to the etalon whose initial separation is s, the change in separation of the etalon is large enough to tune the etalon over the communications band, that being 2% currently. In other words, (Δ1/s)100%>2%.

Typically piezo materials such as PZ29 by Ferroperm A/S can achieve about 0.15% strain, so that for 2% strain to be achieved in the etalon, the piezo tube will be required to be 2/0.15 (approximately 14) times longer than the separation of the etalon.

FIG. 12 illustrates the use of Bragg elements 1200 in the free space array, the diameter of the element being about 0.5 mm and the elements having about 2000-2500 reflections per mm which translates to a basic pitch of about 0.4 μm. The element is typically 3 mm long. These elements can be tuned electrically, the Bragg element being made of a material whose refractive index changes with applied voltage. The material might comprise a 35 semiconductor from the gallium arsenide system having internal electrodes made of transparent material such as indium tin oxide (ITO). Alternatively these elements can be tuned mechanically in either compression or tension. Alternatively these elements can be made of a material whose refractive index changes with temperature. Alternatively these elements can be tuned by tilting but this would result in high losses and a broad response and is not often recommended.

Alternatively, the element of FIG. 12 may be a lithium niobate modulator, for example made by Alcatel. Such a modulator may be tuned in frequency by changing the wavelength of a microwave input. Also, the amplitude of the beam passed through the modulator can be controlled by changing the amplitude of the actuating microwave radiation.

The array being made of elements with both amplitude and frequency control allows for channel amplitude balancing to be effected.

For a typical application (e.g. 10 GHz data on 40 100 GHz spaced channels in C band (1550 mm)) one needs a tuned channel transmission bandwidth of about 30 GHz, tuneable over 4000 GHz (about 2% in wavelength). For an etalon this requires an etalon element with 40-50 wavelengths round trip and a finesse about 120. The number of wavelengths per round trip sets the gap between successive peaks in transmission. The finesse sets the gap to line width ratio. From both the wavelengths per round trip value and the finesse, the line width at a given wavelength can be determined

Finesse values of up to a few hundred are commercially available at a reasonable cost, the cost being a function of the finesse. For this cost reason a fairly low finesse is desirable which means that the number of wavelengths per round trip should be as high as possible to give the narrowest gap between successive peaks. The number of wavelengths per round trip is chosen such that the whole C band can be covered with no ambiguity, the other peas being just outside of the band of interest, leading us to a value of 50. The finesse is then set to give an acceptable line width, in this case, a finesse of 120.

A bandpass filter could also be used to remove additional peaks.

The number of wavelengths per round trip and finesse given above relate to a current communication protocol and allow the etalon to the cover of the whole ITU band without ambiguity. For a different protocol, different values of the finesse and wavelength per round trip may be appropriate.

These elements may be etalons of the following types

FIG. 13 illustrates a direct etalon 1300. The outside surfaces 1302 are coated with an anti-reflection coating and the inside surfaces 1304 are mirrored. The gap 1306 between the two plates 1308 is moveable and is 25+/−0.25 μm.

Indirect

FIG. 14 illustrates a stepped wedge etalon 1400. The effective gap 1402 between the plates 1404 is modified by the introduction of a stepped wedge 1406 of glass which modifies the path length. Each step 1408 in the glass is about 1 μm.

FIG. 15 illustrates a matched taper wedge etalon 1500. The effective gap 1502 between the plates 1504 is modified by moving the wedge 1506 in and out.

The indirect methods have the advantage of much better tolerance to alignment etc but may suffer from internal reflection which would lead to loss.

Alternative etalon structures may be used for the purposes of this device including:

FIG. 16 illustrates an electrically tuned etalon 1600. 25 μM thick optically active material 1602 is provided wherein the refractive index changes by 2% with applied voltage. This material might be doped silicon. There are dielectric stack reflectors 1604 where reflectance R=99.2%. Inner electrodes conductive. Might be ITO (indium tin oxide) or very thin aluminium. Area 0.5 mm*0.5 mm

FIG. 17 illustrates a mechanically tuned etalon 1700, strain 0.5 μm over 25 μm which is 2%. Stack 1702 has reflectance 99%.

Actuator techniques

FIG. 18 illustrates a piezoelectric tube etalon 1800. Inner diameter ID=0.6 mm, outer diameter OD=1 mm, V=0-150V, length=3 mm

FIG. 19 illustrates an electrostatic etalon 1900.

FIGS. 20a and 20b illustrate the reflections that take place on the transit beam reflector block 920. Referring to FIGS. 20a and b, the block is composed of 2 alternating sections called even (FIG. 20a) and odd (FIG. 20b). The even section 2000 moves 1-2, 3-4, 5-6 . . .(z−1)-z and the odd section 2002 moves 2-3,4-5, 6-7 and swaps the two ends 1-z. This design works for an even number of transit paths. The diagram illustrates the embodiment for 10 transit paths.

The block can be made of mirrors or prisms or retro-reflective material, for example.

FIGS. 20c, d and e show views of the block 920 having raised sections 921 and v-shaped sections 923.

FIG. 21 illustrates the transit paths resulting from transit beam reflector block as shown in FIGS. 20a and b.

There are many transit paths which could be used. This is a design parameter of the transit beam reflector block and may be designed in a number of ways. It is not important what the transit path is, but simply that it is known by the computer which controls the system.

FIG. 22 shows an example of an optical switch 2200 where the switching elements comprise widely tuneable frequency selective elements 2202, for example tuneable mirrors and widely tuneable electroholographic switch elements 2204. m input fibres 2206 and M output fibres 220 are shown. n wavelengths are to be switched from each fibre.

The arrangement shown in FIG. 22 should be contrasted with those of International Patent Application No. WO01/07946 in which frequency selective elements are set to a specific frequency. For those arrangements, for m input fibres, M output fibres, n wavelengths, we would require m*M* electroholographic switches and m*n frequency selective elements (diffraction gratings) which is a very large number and thus the arrangement is not suitable for scale up.

Here, as shown in FIG. 22, the elements 2202 and 2204 are widely tuneable and thus each electroholographic element 2204 and the gratings 2202 could be used for any wavelength. In the case of the electroholographic switch, this could be achieved for example by writing each electroholographic switch (for each wavelength) at different angles in a single element and changing the angle of the element in use. In the arrangement of FIG. 22 then we require M*n electroholographic switches and m*n frequency selective elements. (Have m<n for fully non-blocking.) Ours has 2*M*n frequency selective elements,<=n. This can be significantly fewer elements than required for the arrangements of WO01/07946.

The electroholographic switches 2204 can include amplitude control, such that each channel can have amplitude control from using electroholographic switches. Hence in the example of FIG. 22, where there are half electroholographic switches and half tuneable mirrors channel balancing can be achieved. In an alternative arrangements, all of the elements could be electroholographic switches, although it is thought that there is lower loss when half tuneable mirrors are used. Alternatively, all of the elements could be tuneable mirrors but then channel balancing possibilities would be lost.

Fibre Bragg Grating Hybrid Example

FIG. 23a is a diagram of a fibre bragg grating (FBG) element 2300. The paths are numbered as previously for FIG. 2a and the operation is as described previously for tuneable frequency dependent hybrid elements. The FBG is tuned by stretching by 2%, stretching/compressing +/−1% which has mechanical advantages or compressing 2% which has further mechanical advantages. Alternatively the FBG can be tuned thermally using fibre with a high thermal coefficient of refractive index.

FIG. 23b illustrates an apparatus by which a fibre Bragg grating can be stretched by, for example, 2%. There is a piezo bender element which has a sufficient movement at the end under load to apply 2% strain to the fibre and FBG. The apparatus if given rigidity and is mounted from a base which might be made of alumnium for example. This is one way of stretching a fibre bragg grating using piezo actuator. Other mechanical gearing systems are possible using both bender and linear piezo actuators.

Further ways of manipulating fibre Bragg gratings are described in pending UK Patent Application No. 0110940.4 filed on May 3, 2001 in the name Andrew Nicholas Dames.

FIG. 24 is a diagram of a 4*4 switch of the general type shown in FIG. 3. There are FBG elements 2300 connected up in a 4*4 switch. The FBG elements are all in the same orientation in this diagram and an element 2300 shows the port labelling which is the same as that used previously.

Input fibres 2400 and output fibres 2402 are shown.

FIG. 25 is a schematic of a device that is the equivalent to the 10*10 switch shown in FIG. 3 but is only 4*4, being the same as the switch in FIG. 24. FIG. 26 is a schematic of the same switch as shown in FIG. 25 but shown in a different way to better reflect the embodiment diagram in FIG. 24. Input fibres 2500, output fibres 2502 and absorbing terminations 2504 are shown. Transfer paths are shown as solid lines; transit paths as broken lines.

The apparatus may also include a control device to control the tuning of the elements in the array. The control device may use a feedback system, for example from capacitive sensors or optical feedback from diodes.

It will be understood that the present invention has been described above purely by way of example, and modifications of detail can be made within the scope of the invention.

Each feature disclosed in the description, and (where appropriate) the claims and drawings may be provided independently or in any appropriate combination.

Any reference numerals appearing in the claims are by way of illustration only and shall have no limiting effect on the scope of the claims.

1. An optical switch comprising an optical input and an optical output, the switch further comprising a wavelength selective switch element for directing light of a selected wavelength between the input and the optical output, and means to tune the switch element to a plurality of different wavelengths.

2. A switch according to claim 1, comprising a plurality of wavelength selective switch elements.

3. A switch according to claim 1, wherein the element is tuneable to any one of the wavelengths of the light to be directed from the optical input to the optical output.

4. A switch according to claim 1, wherein the tuneable switch element comprises means selected from the group comprising: a Bragg grating; a fibre Bragg grating; and an etalon.

5. A switch according to claim 1 wherein the means to tune the switch element is an electrically tuneable means.

6. An optical switch having an optical input and optical output, and further including a wavelength selective switch element with means to direct light from the optical input to the optical output.

7. A switch according to either of claims 1 and 6, further including a light transit path for transferring light between an optical input and an optical output, and including a first switch element for directing light from the input onto the light transit path.

8. A switch according to claim 7, wherein the switch includes a plurality of optical inputs, a plurality of switch elements, and means whereby said switch elements direct light from the plurality of optical inputs onto the light transit path.

9. A switch according to claim 7, wherein the switch incorporates means whereby the transit path directs light of a selected wavelength.

10. A switch according to claim 7, further including a second switch element for directing light from the transit path to an optical output.

11. A switch according to either of claims 1 and 6, further including a light transfer path for transferring light from an optical input to an optical output.

12. A switch according to claim 11, further including a transit path and including a first switching element arranged to direct light of a selected wavelength from a first transfer path to said transit path.

13. A switch according to claim 12, including a second switching element arranged to direct light from the transit path onto a second transfer path.

14. A switch according to claim 7, including a plurality of transit paths and a plurality of switch elements, the number of switch elements being twice the number of transit paths.

15. A switch according to claim 11, further including a plurality of transit paths and wherein a transfer path includes a plurality of switching elements for switching a plurality of different wavelengths from the transfer path to the transit paths.

16. A switch according to claim 1, wherein the transfer path includes a break.

17. A switch according to either of claims 1 and 6 including a mirror element for reflecting light in the switch.

18. A switch according to either of claims 1 and 6, including a plurality of outputs and separating means for increasing spatial separation of the light beams at the output ports.
